(19) United States
(12) Patent Application Publication
(10) Pub. No.: US 2026/0350142 A1
(43) Pub. Date: Nov. 5, 2026

(54) PROVIDING SECURE ACCESS TO SENSITIVE DATA FOR DEVELOPMENT IN AN INTERACTIVE DEVELOPMENT ENVIRONMENT

(71) Applicant: Oracle International Corporation, Redwood Shores, CA (US)

(72) Inventors: Shreyas Vinayakumar, Santa Clara, CA (US); Pranav Varia, Bothell, WA (US); Colin J. Schmidt, Playa Vista, CA (US); Denesh Kumar Krishnan Rajaram, Bellevue, WA (US); Anupreet Kalra, Redmond, WA (US); Zengjin Wang, Redmond, WA (US)

(21) Appl. No.: 19/195,079

(22) Filed: Apr. 30, 2025

(51) Int. Cl. G06F 21/53; G06F 21/54; G06F 21/60

(52) U.S. Cl. CPC G06F 21/53; G06F 21/54; G06F 21/602; G06F 2221/033

(57) ABSTRACT

Techniques for providing secure access to sensitive data for development in an interactive development environment (IDE) are provided. In one technique, a first IDE kernel is executed within a first execution environment (EE) and a second IDE kernel, which is a replica of the first IDE kernel, is executed within a second EE that is different than the first EE. In response to receiving a request at the first IDE kernel, one or more components within the second EE (1) retrieve encrypted data that is stored in persistent storage that is communicatively coupled to the second EE and (2) decrypt the encrypted data to generate decrypted data. Also, status data (that indicates that the encrypted data has been stored in a secure data frame of the second IDE kernel) and reference data (that references the secure data frame) are transmitted to the first IDE kernel from the second EE.

### TECHNICAL FIELD

The present disclosure relates generally to machine learning and, more particularly, to providing secure access to sensitive data when developing machine-learned models.

### BACKGROUND

Machine learning is the process of finding patterns in a dataset, generating a model that reflects those patterns, and leveraging the model to make predictions. One computing environment that model developers use to generate and test machine-learned models is a notebook environment, which is an interactive development environment (IDE), an example of which is Oracle Cloud Data Science Notebooks. In a notebook environment, a model developer can create notebook format files, execute cells and add markdown within a notebook UI, open text files, launch a terminal application, and use plugins within the notebook application. A notebook environment allows model developers browse datasets, such as viewing data (e.g., text, images, video) and/or hearing audio data.

However, some datasets (including models that are generated therefrom) include sensitive data about individuals, such as names, biological information, contact information, work information, browsing information, location information, and preference information, which may be derived from other information. Sensitive data refers to audio/video/image/documents and other types of browsable data that is storable in computer-readable media and contains information of commercial value or protected confidential information. Additional examples of sensitive data include microphone recordings, source code, camera video feed/images, financial data, sensor readings, copyrighter works of art, and patient medical records.

Enterprises have incentives (both legal and ethics-wise) for ensuring that sensitive data does not get leaked to third parties, or even exposed to people who are part of their respective organizations, such as model developers who are tasked to generate machine-learned models based on the sensitive data. Current techniques for managing access to sensitive data are very manual, such requiring explicit approval from attorneys on each access, manual masking of data, attending training meetings on best practices in model development to avoid data leaks, etc. Even if only authorized users have actual access to sensitive information, there is still the problem of unethical users, the accidental leaking of sensitive data to people outside of an organization, and the inability for machine learning techniques to find patterns in masked sensitive data (or data that has been de-identified). Thus, there is a need to provide user access to sensitive data in an automated and secure manner.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example computer system for providing secure access to sensitive data, in an embodiment;

FIG. 2 is a flow diagram that depicts an example process for providing secure access to sensitive data in a notebook environment, in an embodiment;

FIG. 3 is a block diagram that illustrates computer system upon which various embodiments may be implemented;

FIG. 4 is a block diagram of basic software system that may be employed for controlling the operation of the computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for providing secure access to sensitive data in an interactive development environment. In one technique, a first kernel executes within a virtual machine (VM) (or other execution environment) of an interactive development environment (IDE). The first kernel is replicated, creating a replica kernel that executes within a replica of the VM (or “replica VM”). The replica VM may be on the same server node (or computing device) as the original VM. In response to receiving a client request at the first kernel, one or more components within the replica VM are caused to (1) retrieve encrypted data that is stored in persistent storage that is communicatively coupled to the replica VM and (2) decrypt the encrypted data to generate decrypted data. The replica VM transmits, to the first kernel, (a) status data that indicates that the encrypted data has been loaded, decrypted, and stored in a secure data frame of the replica kernel and (b) reference data that references the secure data frame. Thereafter, if a request targets the decrypted data for a particular operation, the request includes the reference data, which is used by the second kernel to trigger the particular operation. No process in the original VM is able to access the decrypted data. Instead, processes in the original VM may only invoke methods with respect to the decrypted data.

Embodiments improve computer-related technology related to securely accessing sensitive data in an interactive development environment (IDE). Embodiments involve two different execution environments (e.g., VMs) where developers are only allowed to view non-sensitive data within one of the execution environments (or “untrusted VM”) and where sensitive data is only stored in the other execution environment (or “trusted VM”). Embodiments provide developers with limited access to sensitive data with controls and monitoring in place to ensure that sensitive data is unable to be viewed, listened to, copied, or transmitted out of the IDE. Embodiments provide the developer access to specialized ML hardware accelerators to aid their development of machine learning algorithms using the data loaded in the IDE. Embodiments automatically save artifacts, such as source code, datasets, and model weight files created by the developer, back to secure storage.

### Interactive Development Environment

While terminology pertaining to Jupyter Notebook is used in describing embodiments, embodiments are not limited to Jupyter Notebook. Embodiments are applicable to other IDEs, such as Google Colab, Kaggle Kernels, Deepnote, and CoCalc, PyCharm, JetBrains Datalore, Amazon SageMaker, and Microsoft Azure Notebooks.

A “notebook” is a file or document that contains code, text, and visualizations, often used for data analysis and machine learning. A “notebook session” is an active environment where a notebook is run, including the underlying compute resources (e.g., a virtual machine or a server) and the runtime environment (e.g., Python or R).

A “kernel” is a computational engine that executes the code contained in a notebook, runs and interacts with code in languages (e.g., Python, R, or Julia), and displays the results within the notebook interface. A kernel acts as the “brain” of the notebook, handling the execution of code cells. A kernel manages the execution environment, including the variable namespace, and communicates between the notebook frontend (i.e., notebook application with a web interface) and the backend (the computational engine). Each notebook is associated with a specific kernel, allowing a developer to work with different languages in separate notebooks.

### System Overview

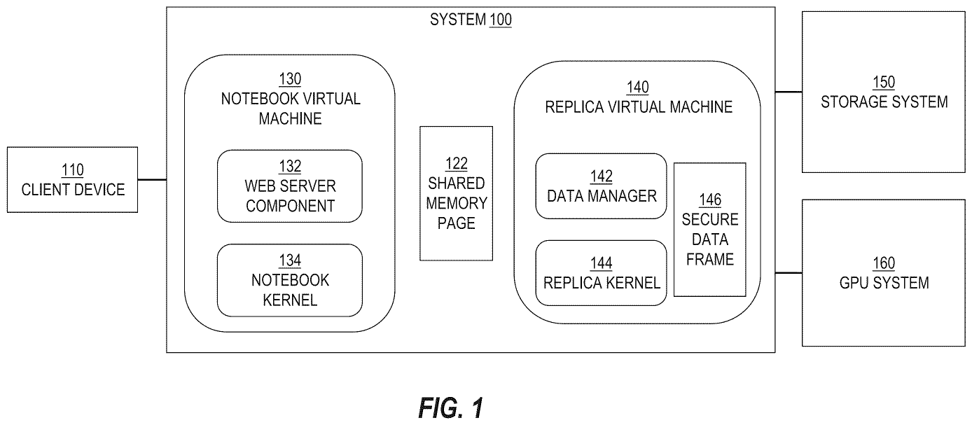

FIG. 1 is a block diagram that depicts an example system 100 for providing secure access to sensitive data, in an embodiment. System 100 comprises a server node 120, a storage system 150, and a GPU system 160. Although only a single instance of each entity in FIG. 1 is depicted, computer system 100 may include multiple instances of one or more of these entities, such as multiple server nodes, multiple storage systems, and/or multiple GPU systems. Also, system 100 may be part of a cloud system that provides cloud resources to multiple customers, whether individual users or organizations. Example cloud resources include compute resources, storage resources, databases, networking, analytics, artificial intelligence, and software applications, all delivered over the Internet.

Client device 110 submits client requests to server node 120 over one or more computer networks, such as a local area network (LAN), a wide area network (WAN), or the Internet. The client requests are submitted based on input from a user operating client device 110. Client device 110 may communicate with server node 120 using one or more communication protocols, such as TCP/IP, HTTPS, and WebSocket. Client device 110 executes a notebook application, whether natively or within a web browser that executes on client device 110.

Although not depicted, an intermediary between client device 110 and server node 120 may accept a connection request from a notebook application executing on client device 110 and routes the connection request to server node 120. After a connection between client device 110 and server node 120 is established, the notebook application thereafter may transmit client requests over that connection to server node 120.

In an embodiment, server node 120 comprises multiple virtual machines: a notebook VM 130 and a replica VM 140. A VM is a software-based emulation of a physical computer. VMs can run programs and operating systems, store data, connect to networks, and do other computing functions. VMs allow multiple operating systems and applications to run concurrently on a single hardware platform. VMs use virtualization technology that allows a single physical computer to host and manage multiple VMs, each with its own resources (CPU, memory, storage, etc.). Replica VM 140 provides separation between a model developer and sensitive data. Replica VM 140 allows model developers to perform certain actions with respect to the sensitive data without allowing model developers to view the sensitive data.

While the following description is in the context of virtual machines, embodiments are not so limited to this type of execution environment. Other execution environments may be used, such as containers. A container is a lightweight, portable, and self-sufficient unit that packages an application along with its dependencies, libraries, and runtime environment, allowing it to run consistently across different computing environments. Containers use operating system-level virtualization to isolate processes and control resource allocation, allowing multiple containers to run on the same host machine without interfering with each other. Because containers are lightweight, they require fewer resources than traditional virtual machines.

Each VM includes a kernel: notebook VM 130 includes a notebook kernel 134 and replica VM 140 includes a replica kernel 144. Notebook kernel 134 stores, in its memory, local variables, a secure data frame variable, and a secure model reference. Replica kernel 144 stores, in its memory, a copy of the local variables from notebook kernel 134 (which copy may be created based on a sync operation between kernels 134 and 144), and a secure data frame, where sensitive data is stored. Values for local variables may be established when a user causes a cell in a notebook application to execute. Non-sensitive data may also be stored as local variables in notebook kernel 134.

Notebook kernel 134 may be replicated in one of multiple ways. One example type of kernel replication is process-level replication, where notebook kernel 134 runs in a container and the container is replicated using CRIU (or Checkpoint/Restore In Userspace, which is Linux software). CRIU freezes a running container (or an individual application) and checkpoints the state of the container to persistent storage, such as disk. The data saved may be used to restore the container and run it exactly as it was during the time of the freeze. Optionally GPU state can also be replicated using cuda-checkpoint. CUDA (Compute Unified Device Architecture) is a parallel computing platform and application programming interface (API) that allows software to use certain types of GPUs for accelerated general-purpose processing. CUDA gives direct access to the GPU's virtual instruction set and parallel computational elements for the execution of compute kernels. In addition to drivers and runtime kernels, the CUDA platform includes compilers, libraries, and developer tools to help programmers accelerate their applications.

Another example of kernel replication is program-level replication, where the entire in-memory state is serialized. For example, in the Python library, “dill” can be used to serialize kernel state. “dill” enables the serialization and deserialization of a wide range of Python objects, including user-defined classes and functions, and allows for the saving and restoring of sessions.

Thus, replica kernel 144 may be an exact byte-for-byte replica of notebook kernel 134 initially. However, over time, replica kernel 144 might not be an exact replica of notebook kernel 134, especially if changes to the state of notebook kernel 144 are eventually propagated to replica kernel 144. Nevertheless, replica kernel 144 may be considered an eventually-consistent replica of notebook kernel 134.

Server node 120 also stores a shared memory page 122, which includes non-sensitive data, which replica kernel 144 stores in shared memory page 122. Examples of non-sensitive data include GPU statistics (generated by GPU system 160 while training a machine-learned model), training statistics (also generated by GPU system 160), and non-sensitive columns. Examples of GPU statistics include GPU utilization, amount of data loaded onto the bus shared with the GPU, time to transfer data, time to perform computation, number of cores used, and high bandwidth memory used. Examples of training statistics include time to perform the training, loss metrics for each epoch, learning rate and its derivatives, and current set of hyperparameters being explored.

Storage system 150 stores data assets for one or more data owners. A data owner is an entity, such as an individual or an organization, that owns or is responsible for one or more data assets. An example of a data owner is a customer of a cloud provider. The customer may be any type of entity. Examples of data assets include machine-learned models, datasets (which may be used to train machine-learned models), and ancillary data associated with a dataset, which ancillary data may provide additional information about items reflected in the corresponding dataset.

Storage system 150 may be logically divided among data owners, allowing each data owner to access its own data assets. A “customer tenancy” refers to a portion of storage system 150 that stores a set of data assets that belong to a data owner. Thus, only a data owner (and its agents/representatives) are allowed to access data assets that are stored in the data owner's customer tenancy. A data asset may be encrypted while it is stored in storage system 150. Each data owner may be associated with its own set of one or more decryption keys that, when retrieved, allows replica VM 140 to decrypt an encrypted data asset associated with that data owner.

GPU system 160 comprises one or more GPU nodes, or nodes that include one or more cores of a graphics processing unit (GPU). A GPU node may comprise multiple GPUs and a GPU may have many (e.g., hundreds or thousands of) cores. A CPU (central processing unit) is a general-purpose processor that handles diverse tasks, while a GPU is a processing unit that is specialized for parallel processing, particularly graphics rendering and other computationally intensive tasks, such as machine learning. For example, a GPU node implements one or more machine learning techniques to train a model based on a dataset. The GPU node also implements one or more testing/validation techniques to test a trained model given another dataset or a portion of the dataset that was used to train the model.

### Onboarding

In the context of a cloud system where an organization desires to provide secure access to sensitive data stored in the cloud, the organization provides an onboarding process to each model developer to create an account with an Identity service and register a hardware security module along with a personal computer and an authentication method (e.g., password or biometric scanner). The organization owns several data assets stored in storage system 150 and protected from otherwise being accessed using network policies, Identity policies, and encryption. A model developer may refer to data assets by name or location. Data assets may be of several types, such as datasets, model weights, machine learning algorithms either in source code or serialized format, execution environments, and software packages. Some data assets may be classified as sensitive while others may be non-sensitive.

As part of the onboarding process, the organization grants the account of a model developer access to launch a notebook with some or all data assets owned by the organization. Following the onboarding, the organization provides a notebook application to the developer. The developer connects to the Internet (or a private network), launches the notebook application on the developer's personal/work computer (e.g., client device 110) and is prompted to login to an Identity service using a hardware security module (HSM). The Identity service issues a token, which the notebook application stores and which is provided to a component in system 100 in subsequent interactions.

The notebook application displays a user interface (UI) that comprises a graphical button for opening (or launching) a notebook creation form. Upon the user selecting the button, a model developer is prompted, through the UI, to enter details of the sensitive and non-sensitive data assets that the developer desires to access through the notebook application. Once the details are entered, another button appears on the screen to launch the notebook.

In an alternative embodiment, a model developer uses a command line interface (CLI) to issue a command to start a notebook session. In this embodiment, parameters to the command are used instead of the form, and issuing the command takes the place of clicking the (launch) button.

Upon detection that the developer desires to launch a notebook (e.g., due to the developer clicking a launch button), the notebook application issues a request to a workload manager, which may execute on server node 120 or another server, not depicted. The workload manager makes a call to the Identity service, verifying whether the developer has permissions to launch a notebook with the requested assets. If the developer has the necessary permissions, then the workload manager responds back to the notebook application with a task identifier (ID) that may be queried to track the progress of the notebook launch. The notebook application may periodically query the status of the task. Meanwhile, the following sequence of operations may be triggered.

First, a notebook manager (executing on server node 120 or another server, not depicted) initiates data transfer of non-sensitive data assets to a storage device HD1. Alternatively, the storage is made available through network and policy configuration followed by filesystem mounting instead of transfer. Second, upon successful transfer, the workload manager sends a request to a workload agent to launch a notebook server on server node 120. The workload agent communicates the port and information of server node 120 to a notebook router along with a URL. Alternatively, the association of URL to port and server is determined based on an algorithm that considers the location or IP address of server node 120. Alternatively, the notebook router generates the URL and communicates it to the workload manager instead. Third, the notebook manager updates a database with the URL of the notebook and an ID of the notebook and marks the status of the task as completed.

Once the status is marked as complete, when the notebook application queries the status of the task, the notebook application receives the notebook ID and its corresponding URL from workload manager. The notebook application presents, in the UI, a button that, when selected by the developer, causes the URL to be presented in a browser application. (In an embodiment, the browser is integrated with the notebook application rather than being a separate application.) The developer can log in to the notebook application later and click the button corresponding to the same notebook, which appears by virtue of the notebook application listing the notebooks known to workload manager and owned by the organization. Another developer (with access granted by the organization) may also click the same button using their instance of the notebook application on their own computing device to open the same notebook.

The browser is any application (e.g., Mozilla Firefox, Google Chrome, or Safari) that renders HTML/CSS, executes Javascript, and comes pre-installed with digital certificates from public certificate authorities. In an embodiment, the browser is a specialized application, such as Respondus Lockdown™ that: (1) only allows launching in full screen mode; (2) disables screenshot functionality; (3) captures live video from a camera of the computing device (e.g., client device 110) and saves the live video to a remote storage location for review, if needed; and (4) flags suspicious behavior using video recognition technology, such as using a mobile phone to take photos or recordings of the screen. In a related embodiment, a browser extension, such as Proctorio™, is used to achieve (1)-(4) with a commonly-used browser.

The browser may verify the identity of the notebook manager using certificates and a trust chain. Once the URL is resolved by the browser to the IP address of the notebook manager and port of the notebook router, the following sequence of operations may commence. The browser receives static web page elements and a web client (or “notebook client”) in the response. The browser renders the static elements and executes the notebook client code. The notebook client code opens a connection to the notebook router, which in turn opens a connection to a notebook server running on server node 120. The notebook server creates a session object in memory corresponding to the notebook client and browser. The notebook client code renders the dynamic elements of the page based on the response from the notebook server.

### Launching a Notebook

In an embodiment, model developers are provided with the ability to launch secure notebooks. A secure notebook comprises a web server component 132 and a kernel 134, which is a standalone process that runs in the background and executes code. (In Apache Zeppelin, the “kernel” is referred to as an “interpreter”). When a secure notebook is launched within a notebook VM 130, a replica VM 140 is launched on the same server node (e.g., server node 120), and a shared memory page 122 is allocated, and a secure inter-process communication (IPC) is set up for communication between notebook VM 130 and replica VM 140. Replica VM 140 is a trusted VM where no code of the secure notebook is executed. Thus, notebook VM 130 may be considered an untrusted VM.

In a related embodiment, replica VM 140 is a trusted execution environment (TEE). A TEE is a secure, isolated area within a processor that protects the confidentiality and integrity of code and data executed within it, ensuring sensitive information remains secure even if the main system is compromised. A TEE operates in isolation from the main operating system and other applications, using hardware-based memory encryption to protect code and data. With a TEE, neither a cloud provider nor a hypervisor on server node 120 is able to access data within the TEE. Another benefit of a TEE is that a TEE allows for remote attestation, which is a security mechanism that allows a remote entity to verify the integrity and authenticity of a system or application running on another machine, ensuring that the system/application is in a trusted state before the system/application accesses sensitive data or “sensitive” operations, such as transmitting sensitive data to another device.

In a related embodiment, replica VM 140 resides on a server node that is different from server node 120. Such a scenario would require inter-node communication (which has more latency than IPC), encrypting data before transmission to the other server node, and decrypting data upon receipt from another server node. Thus, this embodiment experiences higher latency than the single server node scenario described herein.

Within trusted VM 140, a replica kernel 144 of notebook kernel 134 is spawned. Replica kernel syncs local variables from notebook kernel 134 and is eventually consistent with the state of notebook kernel 134. Examples of local variables include values loaded from non-sensitive datasets, parameters from non-sensitive models, tokenizers, configurations, and environment variables.

Model developers are provided with a library to work with sensitive data within a notebook. Model developers are able to view and work with non-sensitive data without any restriction in the notebook, and add code that uses the library in any notebook cell. The library does not provide developers direct access to the underlying data. Instead, the library provides access to methods. Such methods are described as follows.

### Loading a Data Asset into a Secure Data Frame

In an embodiment, notebook kernel 134 makes a library call over a secure IPC to replica kernel 144. The library call is to load data from storage system 150 into replica VM 140. The library call includes a reference to the data, such as a name of a data asset, a pathname, or other storage location identifier (e.g., a uniform resource locator (URL)). The library call may be initiated in response to web server component 132 receiving a client request from client device 110. The client request is generated in response to a user/model developer interacting with a cell in a notebook application, which executes on client device 110. A mapping between data asset names and unique data asset identifiers may be stored on client device 110 (and accessible to notebook application) and/or stored on notebook VM 130. Thus, either the client request includes a data asset identifier or the client request includes a data asset name, in which case a component of notebook VM 130 performs a lookup of the data asset identifier (using the data asset name) in the mapping.

The library call to load data from storage system 150 into replica VM 140 may be as a result of eager loading or of lazy loading. An example of eager loading is a request to create a secure data frame, which request may trigger the immediate loading of sensitive data into replica VM 140. An example of lazy loading is a request to load sensitive data onto a GPU or read non-sensitive data for viewing in notebook kernel 144. An example of the lazy loading scenario is the following:
(a) df=load_dataset(‘foo’)
(b) df1=load_dataset(‘bar’)
(c) df.normalize( )
(d) df[‘col1’].one_hot_encode( )
(e) df.to_device(rank=0)//at this point, calls (a)-(e) are executed
(f) df1.preprocess( )
(g) stats=df1.count(x>100)//non-sensitive operation that permits viewing, triggers loading and execution
   While the call in (a) might result in a reference to a secure data frame (‘df’), the reference does not necessarily reference any data initially. Even calls in (c)-(d) do not necessarily result in loading of sensitive data, the call in (e) triggers the loading of the dataset ‘foo.’ Similarly, the call in (b) does not trigger the loading of the dataset ‘bar.’ However, the call in (g) triggers the calls in (b) and (f) to be performed, prior to performing the call in (g).

In response to receiving the library call from notebook kernel 134, replica kernel 144 may sync its local state with notebook kernel 134 if such syncing has not yet happened. Additionally, syncing may occur at different times in response to certain events (and not just in response to a library call to load data), such as the lapse of a certain amount of time and/or after a certain number of changes to local variables. Alternatively, syncing may occur in response to each change to a local variable in notebook kernel 134. Thus, replica kernel 144 may skip a syncing operation in response to receiving the library call.

In response to receiving the library call to load data, replica kernel 144 calls a data manager 142, which retrieves the data and decrypts it. In a related embodiment, replica kernel 144 performs these functions. Thus, in this embodiment, replica kernel 144 incorporates the functionality of data manager 142. However, the following description refers to data manager 142 performing those functions.

Data manager 142 transmits, to storage system 150, a data asset request that includes the reference (which was passed from notebook kernel 134 to replica kernel 144 and then to data manager 142). The data asset request may have additional data, such as an identity of the data owner of the data asset and/or one or more credentials (e.g., a username and password) that grant, to data manager 142, access to the data asset. Storage system 150 identifies, based on the reference, a data asset that corresponds to (or is identified by) the reference. The data asset may be encrypted when it is identified. In fact, each data asset that storage system 150 receives for storage may be encrypted. If not, then storage system 150 may encrypt the data asset using a key that is associated with the corresponding data owner. Storage system 150 transmits, to data manager 142, a response (to the data asset request) that includes the data asset.

Data manager 142 may also transmit, to storage system 150, a key request for a key to decrypt the encrypted data asset. A set of one or more keys of a data owner may be stored in the same customer tenancy as the customer tenancy that stores the data assets of the data owner. If there are multiple keys, then different keys may be associated with different data assets. Thus, the key request may include the reference to the data asset, which storage system 150 may use to identify the appropriate key. Storage system 150 responds to the key request by transmitting the identified key to data manager 142, which decrypts the retrieved data asset using the retrieved key.

Data manager 142 may transmit the key request to storage system 150 after receiving the data asset from storage system 150, or before receiving the data asset from storage system. For example, data manager 142 may transmit the data request and the key request at the same time, either in parallel or serially.

In an embodiment, each data asset in storage system 150 is presumed to be encrypted and classified as sensitive. Thus, each retrieved data asset requires a key to decrypt the data asset. In an alternative embodiment, some data assets stored in storage system 150 are not classified as sensitive and/or are not encrypted. Therefore, data manager 142 determines whether a data asset is sensitive based on analyzing metadata associated with the data asset. Additionally or alternatively, data manager 142 determines whether a key to decrypt a data asset is required based on analyzing metadata associated with the data asset. The metadata of a data asset may be stored in storage system 150 in association with the data asset. If metadata indicates that a data asset is sensitive, then embodiments described herein involving leveraging secure data frame 146 may be used. If metadata indicates that a data asset is not sensitive, then data manager 142 may store the data asset in shared memory page 122, which is accessible to notebook kernel 134. Thus, notebook kernel 134 may provide the data asset and/or data derived therefrom (e.g., a machine-learned model) to web server component 132, which forwards such data to client device 110.

Replica kernel 144 determines that the data asset has been retrieved from storage system 150 and has been decrypted. The data asset is stored in secure data frame 146, which is in memory of replica kernel 144. In response to this determination, replica kernel 144 issues a callback to library code running in notebook kernel 134, indicating that the data asset has been loaded. The callback includes a reference identifier (ID) to secure data frame 146. With this secure data frame reference ID, notebook kernel 134 may reference the data asset without accessing the data asset.

The sensitive data in the secure data frame is stored in the memory of replica VM 140, in which replica kernel 144 executes. The virtualization boundary offered by the hardware and operating system of server node 120 guarantees that notebook kernel 132 cannot access this memory. Only select data can be accessed via predefined requests that client device 110 is allowed to transmit.

With respect to processing a data asset in replica VM 140, wrappers over the underlying framework (e.g., Pytorch or Tensorflow) may be provided. Operations with respect to the data asset are executed in replica kernel 144 on secure data frame 146, based on the secure data frame reference ID that notebook kernel 134 passes to replica kernel 144.

In a related embodiment, a data asset is loaded onto server node 120 “lazily.” In other words, a data asset is loaded only when the data asset is needed, such as in response to a read or write operation with respect to the data asset. This is referred to as “lazy loading.” Thus, in response to a load request, a secure data frame reference ID may be generated and provided to notebook kernel 134 even though the requested data asset is not yet loaded onto server node 120.

### Operations with Resect to a GPU

In an embodiment, replica kernel 144 loads a data asset (that is stored in secure data frame 146) onto a GPU node in GPU system 160. This loading may be performed in response to notebook kernel 134 receiving, from client device 110, a client request to perform a GPU-related operation on the data asset. In response, notebook kernel 134 transmits, to replica kernel 144, an operation request that (1) indicates one or more operations to perform and (2) includes a reference ID that identifies the data asset. In some embodiments, notebook kernel 134 may have access to a GPU and some data could be replicated directly on notebook kernel 134's GPU as well as the replica kernel 144's GPU without involving the CPU on which replica kernel 144 executes. For example, OpenSHMEM implementations (NVSHMEM by Nvidia and ROC_SHMEM by AMD) allow (a) memory to be allocated on a symmetric heap and the contents securely multicast to both GPUs and (b) contents of memory locations to be copied between GPUs based on instructions issued by notebook kernel 134. In response to receiving the operation request, replica kernel 144 identifies (i) the one or more indicated operations and (ii) the data asset in secure data frame 146, transmits the data asset to GPU system 160 if one of the indicated operations is a GPU load operation and/or another type of GPU-related operation, such as model training or model evaluating.

In an embodiment, in response to GPU system 160 training a machine-learned model based on a data asset, replica kernel 144 creates a secure model reference that references the machine-learned model. Replica kernel 144 transmits the secure model reference to shared memory page 122 and notifies the notebook kernel of its availability. Thereafter, the machine-learned model can be evaluated within replica kernel 144 in response to a user operating client device 110 provides input that causes client device 110 to issue a call that includes the secure model reference.

Model evaluation is the process of using various metrics to assess performance of a machine-learned model, identifying strengths and weaknesses of the model and understanding effectiveness of the model. Different metrics to assess performance may be used, depending on the type of problem (e.g., classification or regression) and the specific goals of the evaluation. For example, in classification, metrics include accuracy, precision, recall, F1-score, and AUC-ROC. In regression, metrics include Mean Squared Error (MSE), Root Mean Squared Error (RMSE), and Mean Absolute Error (MAE).

In this embodiment where a secure model reference is created and made available to notebook kernel 134, weights of the machine-learned model remain within memory of replica kernel 144. However, any non-sensitive data of interest, such as training metrics, GPU metrics, and non-sensitive columns are made available in shared memory page 122. An example of a training metric is training loss, which is a metric that measures how well a model performs on the data it was trained on, essentially quantifying the error between the model's predictions and the actual target values during the training process. (Training loss indicates how well the model is learning the patterns within the training data and should generally decrease as the model improves over time.) Methods to read non-sensitive data during and after a training run are available to notebook kernel 134.

In an embodiment, training and/or evaluating a machine-learned model are performed using Differential Privacy methods. Differential Privacy is a mathematical technique that allows researchers to analyze data while guaranteeing that individual-level information remains protected, ensuring that the output of the analysis is not significantly affected by the presence or absence of data of any single person. A goal of Differential Privacy is to balance the need for privacy with the utility of the data, allowing for the sharing of aggregate patterns while limiting the risk of revealing individual-level information. An algorithm is considered differentially private if the output of the algorithm does not change significantly when the data of a single person is added or removed from the dataset. Metadata of a data asset may indicate that the data asset was generated using one or more Differential Privacy methods. In a Differential Privacy embodiment, weights and parameters of a machine-learned model are made available in shared memory page 122, which is accessible to notebook kernel 134. The machine-learned model may be evaluated on non-sensitive data and viewed/inspected by a model developer. Therefore, no secure model reference is necessary.

### De-Identification Operation

In an embodiment, replica notebook 140 allows a de-identification operation to be performed with respect to a data asset, such as a dataset. De-identification is the process of removing or altering information that could identify an individual, enabling organizations to release data while still protecting privacy and complying with relevant regulations.

Client device 110 submits a de-identification request that web server component 132 receives and forwards to notebook kernel 134, which identifies a data asset, such as using a data asset identifier (ID) that is included in the de-identification request. Notebook kernel 134 passes the data asset ID to replica kernel 144, which determines that the data asset ID identifies a data asset in storage system 150.

Replica kernel 144 (or data manager 142) transmits a de-identification request to storage system 150. A destination indicated in the de-identification request may be a de-identification service running in storage system 150, which is responsible for performing a de-identification operation on a data asset that is identified in the de-identification request. The de-identification operation may involve removing personal identifying information (PII) or any other data that is considered “sensitive.” After the de-identification operation is performed, the de-identification service transmits the resulting de-identified data asset (DDA) to replica kernel 144 (or data manager 142). The DDA is made accessible to notebook kernel 134 (e.g., by transmitting the DDA to notebook VM 130) and, thus, to client device 110, which may subsequently request operations to be performed on the DDA, such as viewing the DDA, training a model based on the DDA, viewing weights of the model, and evaluating the model.

In a related embodiment, instead of the de-identification service running in storage system 150, the de-identification service runs in replica VM 140, in which case storage system 150 receives a de-identification request from replica kernel 144, identifies the requested data asset in storage system 150, and transmits the requested data asset to replica VM 140. The requested data asset is encrypted in storage system 150 and in replica VM 140, until replica kernel 144 (or data manager 142) obtains a key to decrypt the data asset. The key may also originate in storage system 150. Thus, this embodiment may involve replica kernel 144 requesting the key from storage system 150. Once the data asset is decrypted, the de-identification service running in replica VM 140 performs one or more de-identification operations on the decrypted data asset, resulting in DDA. Thereafter, replica VM 140 makes the DDA available to notebook VM 130, as described herein.

### Example Process

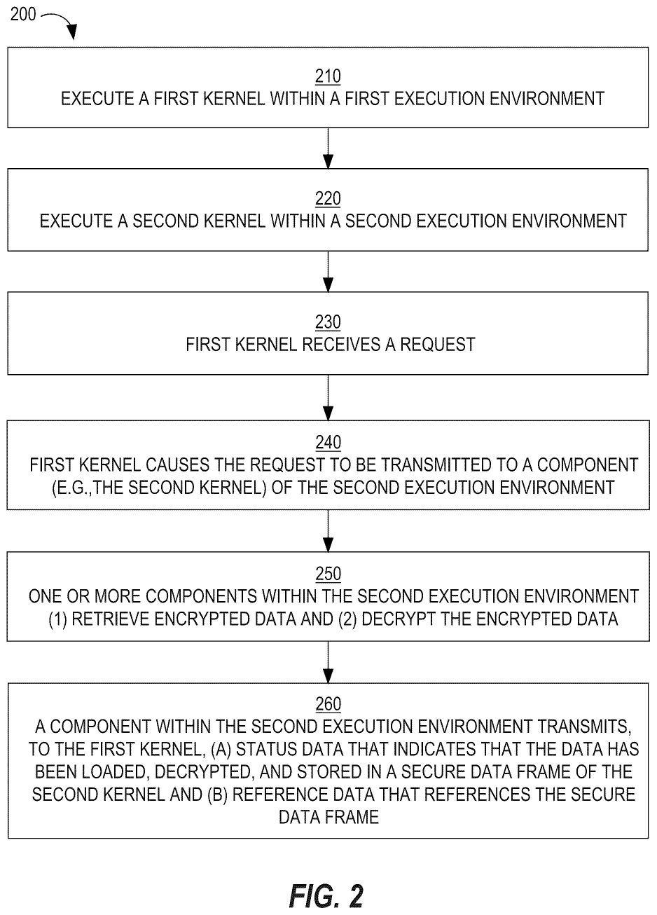

FIG. 2 is a flow diagram that depicts an example process 200 for providing secure access to sensitive data in a notebook environment, in an embodiment. Process 200 is performed by processes within notebook VM 130 and replica VM 140.

At block 210, a first kernel (e.g., notebook kernel 134) is executed within a first execution environment, such as a notebook VM 130.

At block 220, a second kernel (e.g., replica kernel 144) is executed within a second execution environment, such as a replica VM 140. The second execution environment is different than the first execution environment. The second execution environment may reside on the same node on which the first execution environment resides or on a different node than the one on which the first execution environment resides. The second kernel may have been generated by performing a replication operation on the first kernel.

At block 230, the first kernel receives a request. The request originates from a computing device (e.g., client device 110) and may have been received by web server component 132 and forwarded to notebook kernel 134. The request (or the forwarded request) may include a data asset identifier that uniquely identifies a data asset in persistent storage.

At block 240, in response to receiving the request at the first kernel, the first kernel causes the request (or an alternative form thereof) to be transmitted to a component of the second execution environment. Block 240 may involve a first component within the first execution environment (e.g., a plugin in web server component 132 or notebook kernel 134) communicating the request to a component within the second execution environment (e.g., replica kernel 144) in order to retrieve a data asset and decrypt the data asset.

At block 250, one or more components within the second execution environment (1) retrieve encrypted data (e.g., a data asset) that is stored in persistent storage (e.g., storage system 150) that is communicatively coupled to the second execution environment and (2) decrypt the encrypted data to generate decrypted data. Block 250 may involve replica kernel 144 performing these operations. Alternatively, one component in the second execution environment (e.g., replica kernel 144) instructs a third component within the second execution environment (e.g., data manager 132) to do the retrieval and decrypting.

Retrieving the data asset involves sending, to storage system 150, a retrieval request that includes an identifier of the data asset. Decrypting the data asset may involve retrieving a key from storage system 150 and using the key to decrypt the retrieved data asset.

At block 260, a component within the second execution environment (e.g., replica kernel 144) transmits, to the first kernel (e.g., notebook kernel 134) (or to web server component 132), (a) status data that indicates that the encrypted data has been loaded, decrypted, and stored in a secure data frame of the second kernel and (b) reference data that references the secure data frame. Thereafter, components within the first execution environment (e.g., notebook kernel 134) may invoke a call that takes the reference data as input in order to perform an operation with respect to the decrypted data, such as loading the decrypted data onto GPU system 160 and training a machine-learned model based on the decrypted data.

The status data of encrypted data may comprise multiple data items, such as a notebook kernel ID (because some IDEs may have multiple notebooks/kernels that are open concurrently), a cell ID, a name (e.g., a fully scoped name of a variable in the context of the kernel and enclosing cell), a status (e.g., “loaded”), and a unique ID (e.g., a cryptographically secure ID that can be translated to a reference by replica kernel 144).

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

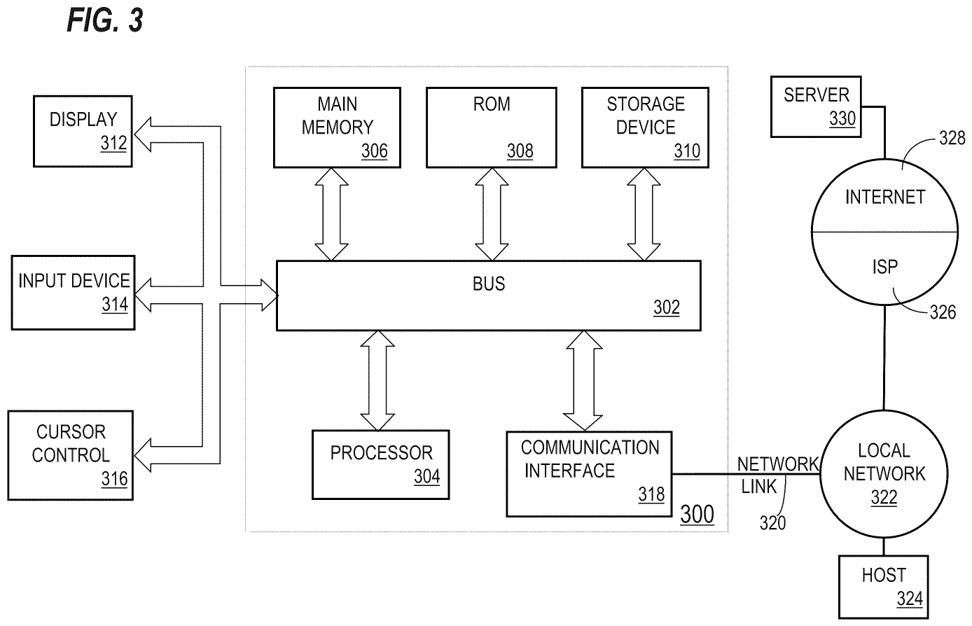

For example, FIG. 3 is a block diagram that illustrates computer system 300 upon which various embodiments may be implemented. Computer system 300 includes bus 302 or other communication mechanism for communicating information, and hardware processor 304 coupled with bus 302 for processing information. Hardware processor 304 may be, for example, a general-purpose microprocessor.

Computer system 300 also includes a main memory 306, such as a random-access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304 including, for example, instructions to execute the functionality described with respect to FIG. 1 and/or FIG. 2. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to network link 320 that is connected to local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to host computer 324 or to data equipment operated by Internet Service Provider (ISP) 326. ISP 326 in turn provides data communication services through the worldwide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, server 330 might transmit a requested code for an application program through Internet 328, ISP 326, local network 322 and communication interface 318.

The received code may be executed by processor 304 as it is received, and/or stored in storage device 310, or other non-volatile storage for later execution.

### Software Overview

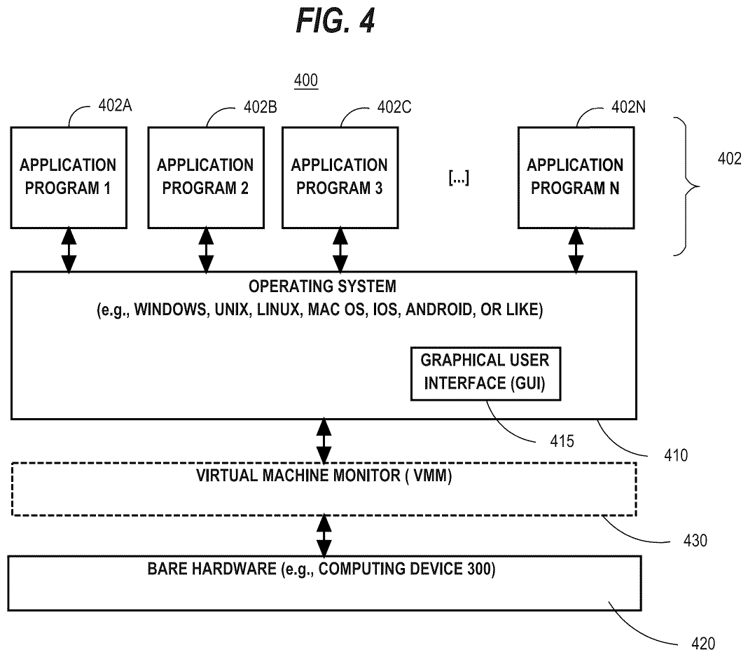

FIG. 4 is a block diagram of basic software system 400 that may be employed for controlling the operation of computing system 400. Software system 400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 400 is provided for directing the operation of computing system 400. Software system 400, which may be stored in system memory (RAM) 406 and on fixed storage (e.g., hard disk or flash memory) 410, includes a kernel or operating system (OS) 410.

The OS 410 manages low-level aspects of computer operation, including managing execution of processes, memory allocation, file input and output (I/O), and device I/O. One or more application programs, represented as 402A, 402B, 402C . . . 402N, may be “loaded” (e.g., transferred from fixed storage 410 into memory 406) for execution by the system 400. The applications or other software intended for use on computer system 400 may also be stored as a set of downloadable computer-executable instructions, for example, for downloading and installation from an Internet location (e.g., a Web server, an app store, or other online service).

Software system 400 includes graphical user interface (GUI) 415, for receiving user commands and data in a graphical (e.g., “point-and-click” or “touch gesture”) fashion. These inputs, in turn, may be acted upon by system 400 in accordance with instructions from operating system 410 and/or application(s) 402. GUI 415 also serves to display the results of operation from OS 410 and application(s) 402, whereupon the user may supply additional inputs or terminate the session (e.g., log off).

OS 410 can execute directly on the bare hardware 420 (e.g., processor(s) 404) of computer system 400. Alternatively, a hypervisor or virtual machine monitor (VMM) 430 may be interposed between the bare hardware 420 and OS 410. In this configuration, VMM 430 acts as a software “cushion” or virtualization layer between OS 410 and bare hardware 420 of computer system 400.

VMM 430 instantiates and runs one or more virtual machine instances (“guest machines”). Each guest machine comprises a “guest” operating system, such as OS 410, and one or more applications, such as application(s) 402, designed to execute on the guest operating system. VMM 430 presents the guest operating systems with a virtual operating platform and manages the execution of the guest operating systems.

In some instances, VMM 430 may allow a guest operating system to run as if it is running on bare hardware 420 of computer system 400 directly. In these instances, the same version of the guest operating system configured to execute on bare hardware 420 directly may also execute on VMM 430 without modification or reconfiguration. In other words, VMM 430 may provide full hardware and CPU virtualization to a guest operating system in some instances.

In other instances, a guest operating system may be specially designed or configured to execute on VMM 430 for efficiency. In these instances, the guest operating system is “aware” that it executes on a virtual machine monitor. In other words, VMM 430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
executing a first interactive development environment (IDE) kernel within a first execution environment;
executing, within a second execution environment that is different than the first execution environment, a second IDE kernel that is a replica of the first kernel;
in response to receiving a client request at the first IDE kernel:
causing one or more components within the second execution environment to (1) retrieve encrypted data that is stored in persistent storage that is communicatively coupled to the second execution environment and (2) decrypt the encrypted data to generate decrypted data;
transmitting, to the first IDE kernel, from the second execution environment, (a) status data that indicates that the encrypted data has been loaded, decrypted, and stored in a secure data frame of the second IDE kernel and (b) reference data that references the secure data frame;
wherein the method is performed by one or more computing devices.

2. The method of claim 1, wherein causing the one or more components comprises:
initiating, by the second IDE kernel, a call to a data manager of the second execution environment;
in response to receiving the call, transmitting, by the data manager, to the persistent storage, a request for the encrypted data.

3. The method of claim 1, wherein causing the one or more components comprises:
causing one of the one or more components to retrieve a decryption key from second storage;
causing one of the one or more components to decrypt the encrypted data with the decryption key.

4. The method of claim 1, further comprising:
in response to receiving, at the first IDE kernel, a second client request to perform one or more operations on the decrypted data, transmitting, by the first IDE kernel, to the second IDE kernel, a request that includes the reference data and that indicates the one or more operations.

5. The method of claim 1, further comprising:
in response to receiving, at the first IDE kernel, a second client request to perform one or more operations on the decrypted data, transmitting, by the first IDE kernel, to the second IDE kernel, a request that includes the reference data and that indicates the one or more operations;
in response to receiving the request, performing, by the second kernel, the one or more operations.

6. The method of claim 1, further comprising:
in response to receiving, at the first IDE kernel, a second client request to perform one or more operations on the decrypted data, transmitting, by the first IDE kernel, to the second IDE kernel, a request that includes the reference data and that indicates the one or more operations;
in response to receiving the request, transmitting a version of the decrypted data to a graphics processing unit (GPU) that performs the one or more operations.

7. The method of claim 1, wherein the one or more operations include training a model, the method further comprising:
in response to receiving, at the first IDE kernel, a second client request to perform one or more operations on the decrypted data, transmitting, by the first IDE kernel, to the second IDE kernel, a request that includes the reference data and that indicates the one or more operations;
in response to receiving the request, causing, by the second kernel, a machine-learned model to be trained based on the decrypted data;
causing, by the second kernel, weights and values of parameters associated with the machine-learned model to be stored in a shared memory page that is on the server and that is accessible to both the first kernel and the second kernel.

8. The method of claim 1, wherein the one or more operations include training a model, the method further comprising:
in response to receiving, at the first IDE kernel, a second client request to perform one or more operations on the decrypted data, transmitting, by the first IDE kernel, to the second IDE kernel, a request that includes the reference data and that indicates the one or more operations;
in response to receiving the request, causing, by the second kernel, a machine-learned model to be trained based on the decrypted data;
causing, by the second kernel, training metrics to be stored in a shared memory page that is on the server and that is accessible to both the first kernel and the second kernel;
causing, by the second kernel, weights of the machine-learned model to be stored in the second kernel and to be inaccessible to the first kernel.

9. The method of claim 1, further comprising:
in response to receiving, at the first IDE kernel, a second client request to perform one or more operations on the decrypted data, transmitting, by the first IDE kernel, to the second IDE kernel, a request that includes the reference data and that indicates the one or more operations;
in response to receiving the request, causing, by the second kernel, a machine-learned model to be trained based on the decrypted data;
causing, by the second IDE kernel, training metrics to be stored in a shared memory page that is on the server and that is accessible to both the first IDE kernel and the second IDE kernel;
causing, by the second IDE kernel, weights of the machine-learned model to be stored in the second kernel and to be inaccessible to the first IDE kernel;
creating a secure model object that references the machine-learned model in the second kernel;
receiving, from the first IDE kernel, at the second IDE kernel, a call that includes a reference to the secure model object;
in response to receiving the call, causing, by the second IDE kernel, using the reference to the secure model object, the machine-learned model to be evaluated with respect to a particular dataset.

10. The method of claim 1, further comprising:
after detecting one or more changes to a first set of local variables that is stored in the first IDE kernel, transmitting the one or more changes to the second IDE kernel;
updating, by the second IDE kernel, based on the one or more changes, a second set of local variables that is stored in the second IDE kernel and that corresponds to the first set of local variables.

11. The method of claim 1, wherein:
the first execution environment is either a first virtual machine or a first container;
the second execution environment is either a second virtual machine or a second container.

12. The method of claim 1, further comprising:
performing a replication operation on the first IDE kernel, wherein performing the replication operation on the first IDE kernel causes generation of the second IDE kernel;
wherein the replication operation is either process-level replication or program-level replication.

13. The method of claim 1, wherein:
the secure data frame is stored in memory of the second execution environment, in which the second IDE kernel executes;
the first IDE kernel is not capable of accessing the memory of the second execution environment.

14. The method of claim 1, wherein the status data comprises two or more of:
an identifier of the first IDE kernel,
a status of the encrypted data,
a variable name of the encrypted data, or
an a unique identifier of the encrypted data.

15. One or more non-transitory storage media storing instructions which, when executed by one or more computing devices, cause:
executing a first interactive development environment (IDE) kernel within a first execution environment;
executing, within a second execution environment that is different than the first execution environment, a second IDE kernel that is a replica of the first kernel;
in response to receiving a client request at the first IDE kernel:
causing one or more components within the second execution environment to (1) retrieve encrypted data that is stored in persistent storage that is communicatively coupled to the second execution environment and (2) decrypt the encrypted data to generate decrypted data;
transmitting, to the first IDE kernel, from the second execution environment, (a) status data that indicates that the encrypted data has been loaded, decrypted, and stored in a secure data frame of the second IDE kernel and (b) reference data that references the secure data frame.

16. The one or more non-transitory storage media of claim 15, wherein causing the one or more components comprises:
initiating, by the second IDE kernel, a call to a data manager of the second execution environment;
in response to receiving the call, transmitting, by the data manager, to the persistent storage, a request for the encrypted data.

17. The one or more non-transitory storage media of claim 15, wherein causing the one or more components comprises:
causing one of the one or more components to retrieve a decryption key from second storage;
causing one of the one or more components to decrypt the encrypted data with the decryption key.

18. The one or more non-transitory storage media of claim 15, wherein the instructions, when executed by the one or more computing devices, further cause:
in response to receiving, at the first IDE kernel, a second client request to perform one or more operations on the decrypted data, transmitting, by the first IDE kernel, to the second IDE kernel, a request that includes the reference data and that indicates the one or more operations;
in response to receiving the request, transmitting a version of the decrypted data to a graphics processing unit (GPU) that performs the one or more operations.

19. The one or more non-transitory storage media of claim 15, wherein the one or more operations include training a model, wherein the instructions, when executed by the one or more computing devices, further cause:
in response to receiving, at the first IDE kernel, a second client request to perform one or more operations on the decrypted data, transmitting, by the first IDE kernel, to the second IDE kernel, a request that includes the reference data and that indicates the one or more operations;
in response to receiving the request, causing, by the second kernel, a machine-learned model to be trained based on the decrypted data;
causing, by the second kernel, training metrics to be stored in a shared memory page that is on the server and that is accessible to both the first kernel and the second kernel;
causing, by the second kernel, weights of the machine-learned model to be stored in the second kernel and to be inaccessible to the first kernel.

20. The one or more non-transitory storage media of claim 15, wherein the instructions, when executed by the one or more computing devices, further cause:
in response to receiving, at the first IDE kernel, a second client request to perform one or more operations on the decrypted data, transmitting, by the first IDE kernel, to the second IDE kernel, a request that includes the reference data and that indicates the one or more operations;
in response to receiving the request, causing, by the second kernel, a machine-learned model to be trained based on the decrypted data;
causing, by the second IDE kernel, training metrics to be stored in a shared memory page that is on the server and that is accessible to both the first IDE kernel and the second IDE kernel;
causing, by the second IDE kernel, weights of the machine-learned model to be stored in the second kernel and to be inaccessible to the first IDE kernel;
creating a secure model object that references the machine-learned model in the second kernel;
receiving, from the first IDE kernel, at the second IDE kernel, a call that includes a reference to the secure model object;
in response to receiving the call, causing, by the second IDE kernel, using the reference to the secure model object, the machine-learned model to be evaluated with respect to a particular dataset.
